(19) United States
(12) Patent Application Publication
(10) Pub. No.: US 2013/0042889 A1
(43) Pub. Date: Feb. 21, 2013

(54) SYSTEMS AND METHODS FOR IMPINGEMENT AIR TREATMENT

(71) Applicants: Dennis J. White, Sandusky, OH (US); Michael E. McDonald, Sandusky, OH (US); Brittan J. Gill, Sandusky, OH (US); Jennifer K. Pickard, Sandusky, OH (US)

(72) Inventors: Dennis J. White, Sandusky, OH (US); Michael E. McDonald, Sandusky, OH (US); Brittan J. Gill, Sandusky, OH (US); Jennifer K. Pickard, Sandusky, OH (US)

(73) Assignee: JOHN BEAN TECHNOLOGIES CORPORATION, Chicago, IL (US)

(21) Appl. No.: 13/214,073

(22) Filed: Aug. 19, 2011

(51) Int. Cl. B08B 5/02

(52) U.S. Cl. 134/15; 15/405

(57) ABSTRACT

A system for impingement air treatment of a thin film conveyor generally includes a thin film conveyor having a width, a first surface, and a second surface, and a first impingement air device configured to blow impingement air on at least one of the first and second surfaces across at least a portion of the width of the thin film conveyor. Other systems and methods for impingement air treatment of conveyors are also provided.

### BACKGROUND

Thin film contact freezers use a finite length thin film sheet to convey products over a refrigerated flat surface or table, as shown and described in U.S. Pat. No. 6,009,719, issued to Ochs. The thin film sheet is supplied in rolls of a predetermined film length and width. A roll of thin film sheet is installed on a supply roller, pulled over the refrigeration table, then collected on an accumulator roller mounted at the discharge end of the table. Therefore, the system operates like a tape cassette that unwinds from one roll and winds on a second roll.

Thin film contact freezers typically operate in the range of about −40° C. to about −52° C. At these freezing temperatures, any water present in ambient air tends to condense on the surface of the thin film conveyor sheet and around the accumulator roll. The ice that accumulates may cause at least one of two problems. First, the ice build-up can cut the thin film sheet, which may create tracking problems that require a system shutdown to re-tie the broken sheet to the accumulator roll. Second, the ice build-up can get caught between adjacent sheet layers on the accumulator roll, resulting in improper film tracking on the accumulator roll.

Such improper film tracking can create bulges and/or wrinkles in the accumulator roll. Wrinkles may reduce the overall width of the conveyor sheet, reducing the available surface for product and also reducing the thermal conductivity to the product where the conveyor sheet overlaps itself at wrinkle locations. Bulges can result in uneven roll stacking, particularly as the roll grows, and may require a premature system shutdown to change out the infeed and accumulator rolls.

During a premature system shutdown, the supply roll is typically replaced to enable a full operating interval after start up, with the remaining material on the supply roll being discarded. Therefore, a premature system shutdown not only results in production loss during the down time for de-icing, but can also result in wasted supply roll material.

To prevent these problems, the freezer systems are typically shut down on a regular basis to de-ice the film conveyor before a more serious problem arises. Therefore, there exists a need for an improved system that either eliminates or greatly reduces ice accumulation on the conveyor sheet to reduce the need for system shutdowns.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with another embodiment of the present disclosure, a system for impingement air treatment of a thin film conveyor is provided. The system generally includes a thin film conveyor having a width, a first surface, and a second surface. The system further includes a first impingement air device configured to blow impingement air on at least one of the first and second surfaces across at least a portion of the width of the thin film conveyor.

In accordance with another embodiment of the present disclosure, a method of impingement air treatment for a thin film conveyor is provided. The method generally includes running a thin film conveyor having a width and first and second surfaces, and cleaning the thin film conveyor by impinging at least one of the first and second surfaces of the conveyor with air across at least a portion of the width of the conveyor.

In accordance with another embodiment of the present disclosure, a method of impingement air treatment for a conveyor is provided. The method generally includes running a conveyor in an environment having a first temperature, and impinging the conveyor with air to condition at least a portion of the conveyor to a second temperature.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a schematic of a contact freezer having a conveyor and an impingement air treatment system in accordance with one embodiment of the present disclosure;

FIG. 2 is an isometric view of an impingement air treatment device shown in FIG. 1;

FIG. 3 is a cross-sectional view of the impingement air treatment device of FIG. 1 through plane 3-3 shown in FIG. 2;

FIG. 4 is a schematic of a contact freezer having a conveyor and an impingement air treatment system in accordance with another embodiment of the present disclosure;

FIGS. 5 and 6 are respective isometric and cross-sectional views of an impingement air treatment device in accordance with another embodiment of the present disclosure; and

FIG. 7 is an isometric view of an impingement air treatment device in accordance with yet another embodiment of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Accordingly, the following descriptions and illustrations herein should be considered illustrative in nature, and thus, not limiting the scope of the disclosed subject matter.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Embodiments of the present disclosure are generally directed to systems and methods of impingement air treatment. Systems and methods described herein are particularly suitable for use in contact heat exchangers, such as contact freezers, for cleaning or de-icing various components of the system. The term cleaning, as used herein, may include removing debris, de-icing ice crystals, drying a wet surface, removing any other matter that may have accumulated in the system, or any combinations of the foregoing.

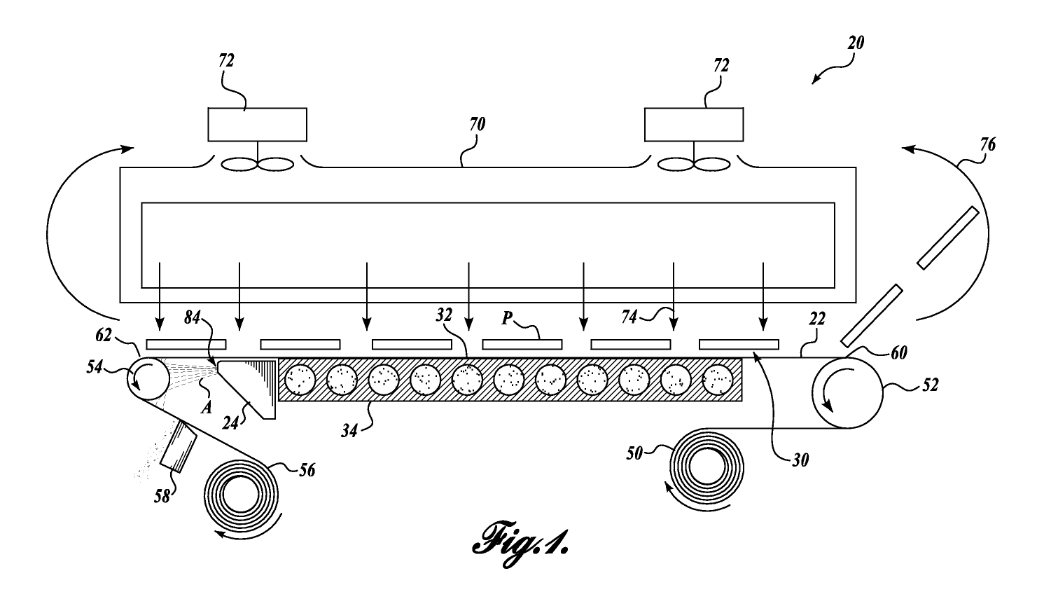

Referring to FIG. 1, a system 20 for impingement air treatment of a conveyor in accordance with one embodiment of the present disclosure can be seen. The system 20 includes a conveyor 22 having a width and first and second surfaces, and an impingement air device 24 configured to blow impingement air A on at least a portion of one of the first and second surfaces of the conveyor 22. As a result of the impingement air treatment, the conveyor 22 is cleaned of particles on one or more of its surfaces. For example, when the impingement air treatment device 24 is used in a contact freezer, the conveyor 22 may be de-iced, for example, any ice crystals that may have formed on any surfaces will be melted. In a contact freezer application, de-icing may be achieved when the surface of the conveyor 22 reaches a temperature greater than about 10° C.

In the illustrated embodiment, the conveyor 22 is a thin film conveyor contact freezer. However, it should be appreciated that other suitable conveyors besides thin film conveyors, such as conveyors having a thickness, are also within the scope of the present disclosure. Moreover, the systems and methods described herein may be used in conjunction with other heat-exchanging processes besides freezing, such as processes for cooking, thawing, sterilization, chilling, etc., that would be improved by impingement air cleaning and/or air drying of the conveying surface. Further, the systems and methods described herein may be used for cleaning in non-heat-exchanging processes.

Although shown and described in the general context of processing food products, it should further be appreciated that the systems and methods described herein may be used with other non-food products suitable for the processes described herein, which may or may not require heat conditioning, whether heating or cooling. As non-limiting examples, other suitable products may include wax molds that requiring cooling and sand that requires cooling for the manufacture of sand paper.

The system 20 shown in the illustrated embodiment of FIG. 1 includes a heat transfer zone 30 for thermal treatment of products P that are being transported on the traveling conveyor 22. The conveyor 22 moves continuously across a thermal surface 32 to thermally condition the contacting surface of the products P by conduction heat transfer through the thermal surface 32 and the conveyor 22.

In addition to the single heat transfer zone 30 shown and described, it should be appreciated that the system 20 may be part of a larger process that incorporates additional heat transfer zones for additional thermal treatment. For example, subsequent refrigeration zones are described in U.S. Pat. No. 6,009,719, issued to Ochs, the disclosure of which is hereby expressly incorporated by reference.

In heat transfer zone 30, the thermal surface 32 is provided by a contact table 34 having a flat upper surface. The conveyor 22 is shown as an elongated sheet or web that is pulled from an infeed supply roll 50 over one or more alignment rollers 52, and then slides or otherwise moves along the thermal surface 32. After use, the conveyor 22 is wound over one or more alignment rollers 54 and collected on an accumulator roller 56. The alignment rollers 52 and 54 may be knurled rollers, for example, having a rough finish in a spiral or other pattern to keep the thin film conveyor 22 spread along the width of the roller and help reduce the tendency of the thin film conveyor 22 to wrinkle during take up.

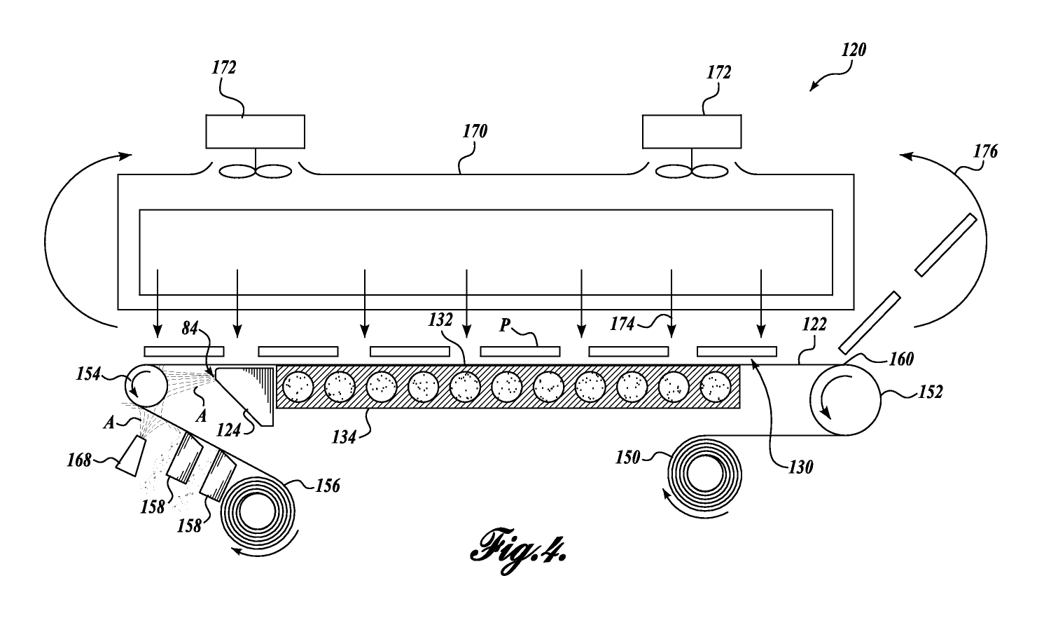

Products P are deposited on the thin film conveyor 22 at the product infeed zone 60, and the conveyor 22 travels across the thermal surface 32, so that heat is transferred by conduction between the products P and the thermal surface 32. The products P exit the conveyor 22 at the product outfeed zone 62. Prior to the accumulator roller 56, one or more surfaces of the conveyer 22 may be scraped by any suitable scraping device 58, for example, a razor scraper. In the illustrated embodiment of FIG. 1, a single scraper is shown for scraping the product-side surface of the conveyor 22; however, it should be appreciated that a plurality of scrapers may be used (see, e.g., the system shown in FIG. 4 includes two scrapers 158), whether on the same side or on opposite sides of the conveyor 22. Such scraping removes food remains from the surface of the conveyor 22 and, by eliminating such debris, allows for improved roll ability of the conveyor 22 on the accumulator roller 56.

The conveyor 22 of the illustrated embodiment is a single, thin film sheet that, once used, is rolled on the accumulator roller 56 and discarded. However, it should be appreciated that continuous conveyor systems or non-continuous reusable conveyor systems are also within the scope of the present disclosure. Suitable thin film conveyor materials include, but are not limited to, about 0.5 to about 1.0 mil polyethylene or other suitable plastic film.

An appropriate drive mechanism (not shown) may be used to drive the infeed supply roller 50, the accumulator roller 56 or both, to control the movement of the conveyor 22 across the contact table 34. The drive mechanism may include conveyor guides, a gear motor driving, for example, the take-up roll onto which the used film is rolled, and a controller to control the film speed. As a non-limiting example, a variable frequency drive (VFD) can be used to vary the speed of the gear motor and the film speed. The controller may further include a speed monitoring device for system feedback and enhanced conveyor speed control.

The thermal surface 32 may be any suitable thermal surface to cause heat transfer to the products P. As a non-limiting example, the thermal surface 32 is a refrigerated surface designed to crust-freeze the bottom surfaces of the products P. In a refrigeration system, the thermal surface 32 may be refrigerated by any suitable refrigeration means including, but not limited to, refrigerant, such as ammonia, that is circulated through the contact table 34 on the underside of the thermal surface 32, cryogens sprayed on the underside of the thermal surface 32, or a cold air blast against the underside of the thermal surface 32.

The thermal surface 32 efficiently transfers heat with the products on the conveyor 22. For example, a thin film contact freezer can be used to crust-freeze the bottom surface of products rapidly through a highly efficient, solid-to-solid heat transfer effect. During this phase, products are carried on the thin continuous film conveyor over the thermal surface, which is cooled to a low temperature on the order of about −40° C. to about −52° C. Upon contact, the product's bottom surface begins to freeze instantly.

The advantage of rapid crust-freezing on the product bottom surface is that product deformation and belt markings can be avoided when the product P is transferred to a traditional open wire mesh belt for further processing. Typically, it only takes about one minute to freeze the product's bottom surface to a depth of about 1 mm, which is a depth sufficient to enable further thermal processing without product deformation or marking. By using a thin film conveyor 22, high hygiene standards can be achieved as a result of the single pass usage of the conveyor 22. This form of crust-freezing reduces the dehydration effect and drip loss typically experienced in conventional mechanical freezing systems by up to 50%, thereby increasing product yields. In addition, drip loss of the product when thawed is also dramatically reduced.

The length of the conveyor 22 in the heat transfer zone 30 can be in the range of about 2 to about 6 meters long. In one embodiment, the heat transfer zone 30 is provided in about 10-foot modules (about 3,000 mm), having a width from about 1.5 to about 7.2 feet (about 450 to about 2,160 mm), with crust-freezing capacities varying from about 100 to about 10,000 pounds per hour (about 45 to about 4,500 kilograms per hour). A contact freezing system, as described herein, is particularly well-suited for difficult products that are soft, sticky, wet, or may need hand-shaping before freezing.

In addition to conduction heat transfer in the heat transfer zone 30 through conveyor 22, the system 20 may further include convection heat transfer. As a non-limiting example, zone 30 may also include a refrigerated air convection quick-freezing subsystem for quick-freezing the top sides of the products. Referring to FIG. 1, the convection subsystem includes an exemplary convection refrigeration assembly 70 located above the conveyor 22. Air fans 72 draft low velocity air through refrigeration coils (not shown) for cooling to a desired freezing temperature, and then push the refrigerated air down onto the conveyor 22 as indicated by arrows 74. The air fans 72 may be configured to re-circulate air from the conveyor course back to the refrigeration assembly 70 continuously. Such recirculation is indicated by the curved arrows 76.

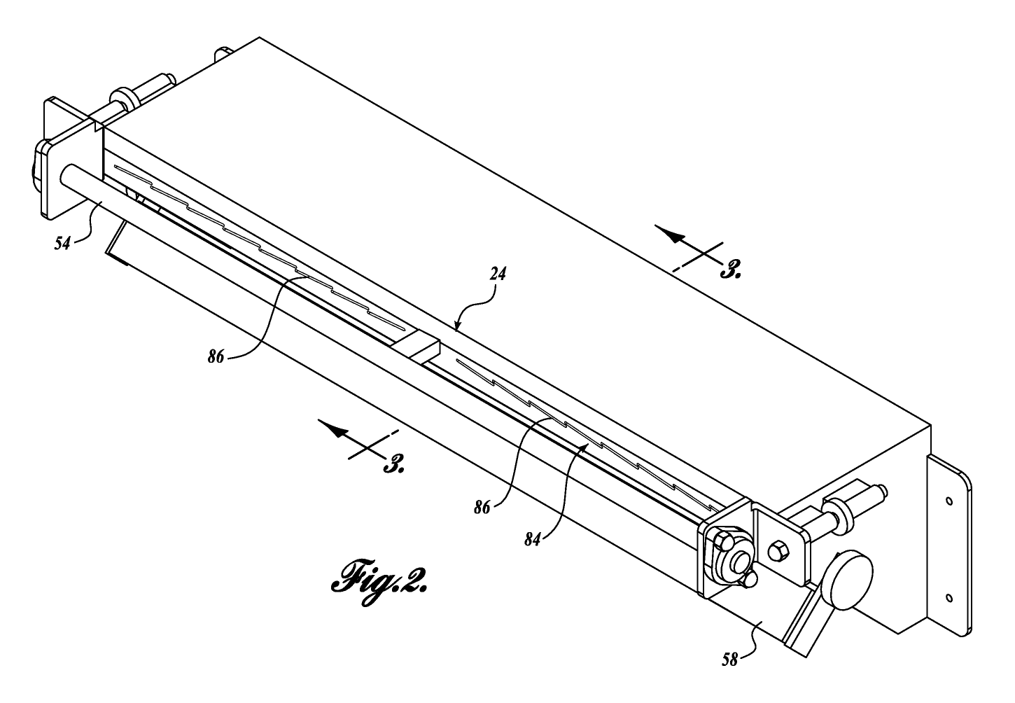

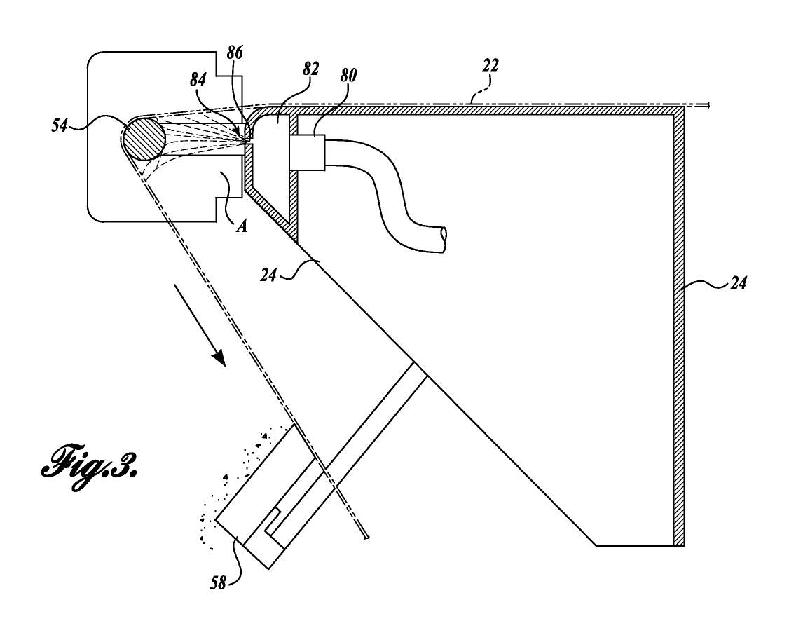

Now turning to FIGS. 2 and 3, the air impingement device 24 used to clean the conveyor 22 will now be described in greater detail. As mentioned above, in an exemplary freezing system, ice particles tend to form on the surface of conveyor 22 and on or near the alignment roller 54, causing damage to the conveyor 22 or resulting in misalignment of the conveyor sheet 22 on the alignment roller 54 and accumulator roller 56. Cleaning of such ice particles from the conveyor 22 using the air impingement device 24 described herein reduces the potential for system shutdown.

The air impingement device 24 is generally located near the product outfeed zone 62. In the illustrated embodiment, the air impingement device 24 is located at the distal edge of the contact table 34. In the illustrated embodiment, the air impingement device 24 directs air A toward the alignment roller 54 and the underside surface of the conveyor 22. However, in other embodiments, impingement air may be directed on one or more surfaces of the conveyor 22. For example, in an alternate embodiment of the system, shown in FIG. 4, a second impingement air device 168 is directed on the product-side surface of the conveyor 22.

As product P exits the conveyor 22, the air impingement device 24 can be used to clean the conveyor 22. In that regard, the air impingement device 24 may be used to de-ice iced surfaces, dry wet surfaces, or clean debris from surfaces of the conveyor 22. As can be seen in FIG. 1, the air impingement device 24 is positioned below the conveyor 22 to clean the underside (freezer side) surface of the conveyor 22 as the conveyor 22 rounds alignment roller 54 and is rolled on accumulator roller 56. However, it should be appreciated that the impingement device 24 may be positioned above and/or below the conveyor 22 to clean either the top or the bottom surface, or both surfaces, of the conveyor 22 (see, for example, FIG. 4).

Referring to FIG. 3, air impingement device 24 includes an air inlet 80, a manifold 82, and an air outlet 84. Air entering at the air inlet 80 from an air source may be compressed air to achieve a certain velocity at the air outlet 84. The air outlet 84 is configured to blow impingement air from the air manifold 82 across at least a portion of the width of the conveyor 22 to clean the conveyor 22 and the alignment roller 54. For de-icing and drying wet surfaces, the air may be at a certain temperature to change the temperature of the conveyor 22 from a first temperature to a second temperature. For example, in a freezer system 20, the impingement air may be from an ambient air source at ambient temperature to remove any ice particles from the conveyor 22. The air may further be conditioned, for example, heated, in the manifold 82 (e.g., using a heat tape) or prior to entering the manifold 82.

In the illustrated embodiment of FIGS. 2 and 3, the outlet 84 includes a plurality of openings 86, shown as spaced-apart, short-length slots. The plurality of openings 86 allows for substantially consistent air velocity across the width of the conveyor 22. In that regard, the inventors found that one, long continuous slot wall tends to collapse in the middle of the slot as a result of the reduction in strength in the manifold wall toward the middle of the slot, and therefore, does not provide for substantially continuous air treatment across the width of the conveyor 22. In one embodiment of the present disclosure, the length of the openings is about 0.4 mm by 50 mm.

Referring to FIG. 2, in the illustrated embodiment, the slots 86 are canted at an angle to allow for overlap between adjacent slots 86. Such overlap helps ensure that the entire width of the conveyor 22 can be cleaned with impingement air to create what is known as an “air knife” or an “air curtain.” Cleaning the entire width of the conveyor 22 helps reduce the formation of bulges and/or wrinkles in the accumulator roll 56 as a result of ice crystals or other debris on the surface of the conveyor 22. Although shown as overlapping, it should be appreciated that non-angled, non-overlapping slots or holes are also within the scope of the present disclosure.

Operation of the system 20 will now be described with reference to FIG. 1. During use, products P are deposited on the conveyor 22, which is fed from supply roll 50 and one or more alignment rollers 52 to the product infeed zone 60. The products P and the conveyor 22 are transported through heat transfer zone 30 across thermal surface 32. At the product outfeed zone 62, products P are discharged and the conveyor 22 is wound around the rounded edge of the air impingement device 24 to one or more alignment rollers 54 and collected on accumulator roller 56. Before being collected on the accumulator roller 56, at least one of the surfaces of the conveyor 22 is treated with impingement air to clean the conveyor 22 of ice or other debris remaining on the conveyor 22. One or more surfaces may also be scraped by one or more scrapers 58 (see FIGS. 1 and 4).

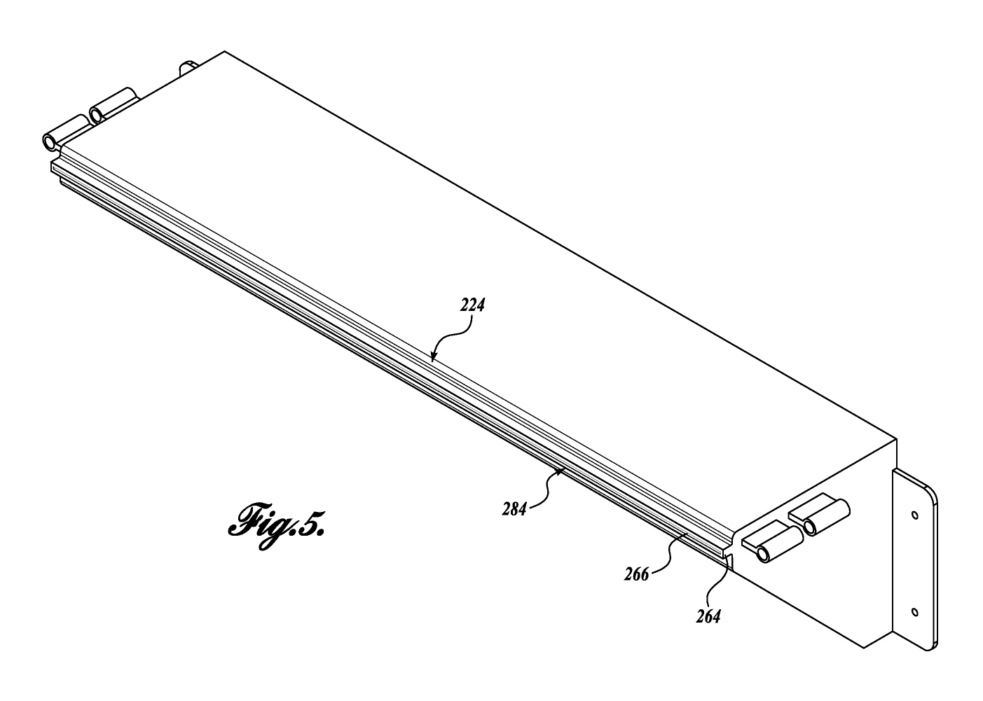

Turning now to FIGS. 5-7, air impinging devices 224 and 324 designed and configured in accordance with other aspects of the present disclosure are shown. It should be appreciated that the various embodiments shown in FIGS. 5-7 are substantially similar to the air impinging device 24 shown in FIGS. 1-3, except primarily for differences regarding the air outlet. Like numerals for the embodiment shown in FIGS. 1-3 are used for the alternate embodiments shown in FIGS. 5-7, except in the 200 and 300 series.

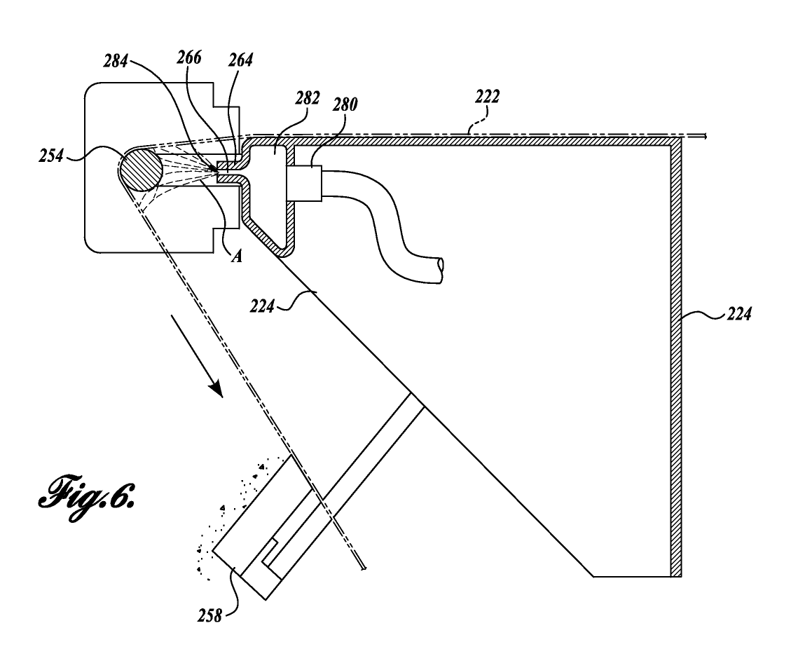

In the illustrated embodiment of FIGS. 5 and 6, the air outlet 284 is an elongated air nozzle 266, which includes an air channel 264 that leads to air outlet 284. As described above with reference to the slot embodiment shown in FIGS. 1-3, the inventors found that one continuous, elongate slot wall tends to collapse in the middle as a result of the reduction in strength in the manifold wall toward the middle of the slot. However, the walls of the air channel 264 in the illustrated elongated nozzle embodiment of FIGS. 5 and 6 provide sufficient structure to prevent collapsing toward the middle of the nozzle 266. It should be appreciated that the air nozzle 266 need not be a long continuous air nozzle, but may be any number of air nozzles in a suitable array.

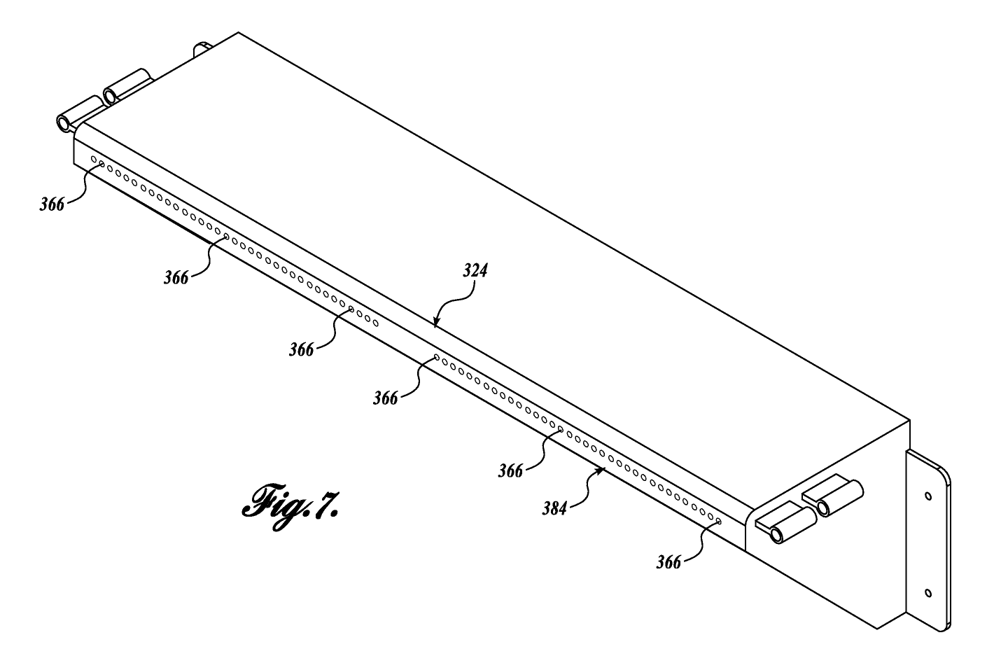

In the illustrated embodiment of FIG. 7, the air outlet 384 is an array of equidistant round holes 366 that can be used to create an impingement air effect on the conveyor (not shown). While slots described above with reference to FIGS. 1-3 tend to create air stream curtains, holes create individual jet streams shaped as cones. Both air curtains and air cones are effective in de-icing the surface or otherwise cleaning the surface of the conveyor.

While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. A system for impingement air treatment of a thin film conveyor, comprising:
(a) a thin film conveyor having a width, a first surface, and a second surface; and
(b) a first impingement air device configured to blow impingement air on at least one of the first and second surfaces across at least a portion of the width of the thin film conveyor.

2. The system of claim 1, wherein the conveyor is at a first temperature, and wherein the impingement air changes the temperature of at least a portion of the conveyor from the first temperature to a second temperature.

3. The system of claim 2, wherein the first temperature is less than about −40° C.

4. The system of claim 2, wherein the second temperature is greater than about 10° C.

5. The system of claim 1, wherein the thin film conveyor is supplied by a supply roller and collected on an accumulator roller.

6. The system of claim 5, wherein the air impingement device is located at a position near the conveyor outfeed prior to the accumulator roller.

7. The system of claim 1, wherein the conveyor is positioned in a refrigerated environment for conduction heat transfer.

8. The system of claim 1, wherein the impingement air device creates an air knife for impinging the conveyor.

9. The system of claim 1, wherein the impingement air device includes an air manifold, an air inlet to supply air to the manifold, and an air outlet to direct impingement air on the conveyor.

10. The system of claim 9, wherein the air outlet includes one or more air nozzles.

11. The system of claim 9, wherein the air outlet is an elongate, continuous opening.

12. The system of claim 9, wherein the air outlet includes a plurality of spaced-apart openings.

13. The system of claim 12, wherein the conveyor travels in a substantially horizontal plane, and wherein the plurality of openings are slots that are angled relative to the travel path of the conveyor.

14. The system of claim 13, wherein the plurality of openings are configured to have overlapping coverage along the width of the conveyor.

15. The system of claim 1, wherein the impingement air is selected from the group consisting of heated air and ambient air.

16. The system of claim 1, further comprising at least one scraper configured to scrape at least one of the first and second conveyor surfaces across at least a portion of the width of the conveyor.

17. The system of claim 1, wherein the system further includes a second impingement air device configured to blow impingement air on at least the other of the first and second surfaces across at least a portion of the width of the conveyor.

18. A method of impingement air treatment for a thin film conveyor, the method comprising:
(a) running a thin film conveyor having a width and first and second surfaces; and
(b) cleaning the thin film conveyor by impinging at least one of the first and second surfaces of the conveyor with air across at least a portion of the width of the conveyor.

19. The method of claim 18, further comprising, after cleaning the thin film conveyor, accumulating the thin film conveyor on an accumulation roller.

20. A method of impingement air treatment for a conveyor, the method comprising:
(a) running a conveyor in an environment having a first temperature; and
(b) impinging the conveyor with air to condition at least a portion of the conveyor to a second temperature.
